(19) United States
(12) Patent Application Publication
(10) Pub. No.: US 2002/0159246 A1
(43) Pub. Date: Oct. 31, 2002

(54) Illuminated display system

(76) Inventors: Matthew Murasko, Manhattan Beach, CA (US); Patrick J. Kinlen, Fenton, MO (US)

Correspondence Address: LATHROP & GAGE LC, 2345 GRAND AVENUE, SUITE 2800, KANSAS CITY, MO, 64108, US

(21) Appl. No.: 10/104,229

(22) Filed: Mar. 21, 2002

Related U.S. Application Data
(60) Provisional application No. 60/277,549, filed on Mar. 21, 2001.
(60) Provisional application No. 60/277,551, filed on Mar. 21, 2001.

(51) Int. Cl. F21V 9/16; F21V 33/00

(52) U.S. Cl. 362/84; 362/127

(57) ABSTRACT

Illuminated display solutions for structures, such as tables and vending machines, are described. In one embodiment, an EL lamp is positioned beneath a light-transmissive table panel such that the lamp may be viewed within a viewing area of a table. Alternatively, the panel can be removed and replaced with an integrated table panel formed of an electrolumienscent lamp and surface framing surrounding the panel. In accordance with one embodiment, the table panel is rotatably connected to an underlying structure. The underlying structure is configured to support an EL lamp thereon such that the table panel can be rotated to overlie the EL lamp. The EL lamp is then viewed through the light-transmissive viewing area of the table panel. Optionally, a table base, such as a pedestal or table legs, may be mounted below the underlying structure to support the entire system. In another embodiment, an electroluminescent lamp is positioned at a reserved area of a panel of a vending machine. The EL lamp can be coupled to the outside surface of the vending machine with a framing system sized to fit over the reserved area, or alternatively, affixed to the inside surface of the vending machine front panel whereby the EL lamp would be viewed through a viewing area that is light-transmissive.

### RELATED APPLICATIONS

This application is a nonprovisional to U.S. application Serial No. 60/227,549, filed Mar. 21, 2001, entitled “APPARATUS AND METHOD FOR INTEGRATING AN ILLUMINATED DISPLAY INTO A TABLE”, and is a nonprovisional to U.S. application Ser. No. 60/277,551, filed Mar. 21, 2001, entitled “METHOD FOR INTEGRATING AN ILLUMINATED DISPLAY INTO A VENDING MACHINE”, which are incorporated herein by reference.

### BACKGROUND OF THE INVENTION

1. Field of the Invention

This invention relates generally to applications for using illuminated displays, and more particularly, for integrating electroluminescent lamps into various structures, such as tables and vending machines.

### Problem

Electroluminescent (EL) lamps emit light by the process of electroluminescence. This process is carried out by the excitation of layer of illuminating material, such as phosphor, in an electromagnetic field, thereby emitting light. Structurally, an EL lamp comprises an illuminating material layer positioned between two electrodes, at least one of which is light-transmissive (i.e. transparent or translucent). One example of such a display is described in U.S. Pat. No. 6,203,391 of Murasko, for an “Electroluminescent Sign”, the teachings of which are incorporated herein by reference. The '391 patent describes forming the component layers of an electroluminescent lamp directly to a sign substrate to form a display. Preferably, the EL lamp component layers are screen printed onto the substrate, and can be built either onto a substrate front surface, or, if the substrate is light-transmissive, onto a substrate back surface.

Tables are known to provide a surface onto which items can be placed, and to provide aesthetic value as a furniture design. Certain table designs include a surface with a removable panel typically made of glass, plastic, or a similar transparent or translucent material. Similarly, vending machines typically have a front panel made from transparent or translucent material, such as polycarbonate plastic. This configuration allows for the viewing of items for sale therein, or for advertising images or design displays (e.g., words, logos, icons, etc.) to be formed onto the panel.

Various illumination solutions have been proposed for vending machines and other structures having similar transparent or translucent paneling. For example, flouresent bulbs can be positioned behind a panel to illuminate a display image formed onto the panel. This design is generally known as backlighted fluorescence, and is well known in the art to be used in vending applications. Neon lighting is also known to be used in this fashion. However, both fluorescence and neon lighting fixtures are breakable, costly to ship, require frequent maintenance, and generally unable to deliver both movement of different elements of a lighted display and the ability to be formed to represent exact logos or icon images.

### Solution

The present invention provides an illuminated display system in which electroluminescent panels are integrated into a variety of structures, such tables, vending machines, and the like. In one embodiment, an EL lamp is positioned such that light from the lamp may be transmitted through a viewing area of a table. In this design, an EL lamp can be placed beneath a removable light-transmissive table panel. Alternatively, the panel can be removed and replaced with an integrated table panel formed of an electroluminescent lamp and surface framing surrounding the panel. In accordance with one embodiment, the table panel is rotatably connected to an underlying structure. The underlying structure is configured to support an EL lamp thereon such that the table panel can be rotated to overlie the EL lamp. The EL lamp is then viewed through the light-transmissive viewing area of the table panel. A lamp controller may be used to control the illumination of discrete parts of the EL panel. Optionally, a table base, such as a pedestal or table legs, may be mounted below the underlying structure to support the entire system.

In another embodiment, an electroluminescent lamp is positioned at a reserved area of a vending machine. The EL lamp can be coupled to the outside surface of the vending machine with a framing system sized to fit over the reserved area, or can be affixed to the inside surface of the vending machine front panel whereby the illuminated design would be viewed through a reserved area that is light-transmissive. A power supply and optional controller can be electrically coupled to the EL lamp to provide power for illumination and control over how discrete parts of the lamp are illuminated. The power supply can optionally be the same power supply as that used by the vending machine.

These display systems allow electroluminescent lamps to be easily switched out for other EL lamps illuminating in specific designs and patterns. Thus, structures having EL lamps integrated therewith may serve as advertising mediums. For example, an EL lamp may illuminate as the logo for a beverage company. In this way, a restaurant or other establishment could place an EL lamp—in the form of illuminated display image of one of the products sold at the establishment—below a panel of a table, or behind the front panel of a vending machine, for viewing by customers. To change an advertisement, the panel may simply be opened or removed, and the EL lamp exchanged for one having a different display image. Similarly, when a product for sale in the vending machine is replaced, the EL lamp can also be exchanged. Furthermore, because an EL lamp can be manufactured to have a very compact and thin form factor, exchanging the EL lamp display is more simple and straightforward than exchanging a bulky neon or backlight fluorescent design. Another use of the table and display apparatus would be for a general illumination effect of a certain region of the table. Other advantages and components of the present invention will become apparent from the following description taken in conjunction with the accompanying drawings, which constitute a part of this specification and wherein are set forth exemplary embodiments of the present invention to illustrate various features thereof.

### BRIEF DESCRIPTION OF THE DRAWINGS

FIG. 1 is a perspective view of an integrated electroluminescent lamp and table system in accordance with an embodiment of the present invention.

FIG. 2 is a perspective view of an integrated electroluminescent lamp and table system in accordance with another embodiment of the present invention.

FIG. 3 is a perspective view of an integrated electroluminescent lamp and table system in accordance with another embodiment of the present invention.

FIG. 4 is a perspective view of an integrated electroluminescent lamp and vending machine system in accordance with an embodiment of the present invention.

FIG. 5 is a perspective view of an integrated electroluminescent lamp and vending machine system in accordance with another embodiment of the present invention.

### DETAILED DESCRIPTION OF THE INVENTION

The present invention is directed to illuminated display systems in which electroluminescent lamps are integrated into structures having a viewing area, such as tables, vending machines, and the like, to enable a person to view a displayed image illuminated by the EL lamp. This arrangement provides a light source that may be made into the shape of illuminated images (wording, logos, icons, etc.) that emanate from a structure, providing, for example, an advertising or promotional function. In addition, the illuminated display of the present invention can provide general illumination for a specific region of a structure, such as the front panel of a vending machine or a portion of a table surface.

### Integrated EL Lamp and Table System

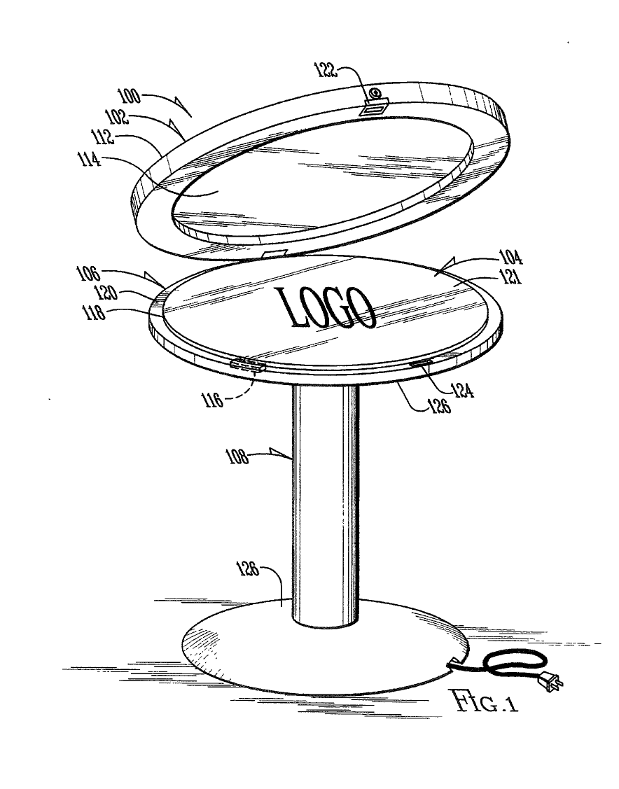

FIG. 1 presents an embodiment of the present invention for an integrated electroluminescent lamp and table system 100. The system 100 comprises a table panel 102, an electroluminescent lamp 104, and an underlying support 106. Also, a table base 108 and a hinge mechanism 110 may be provided; the base 108 adds structural support to table panel 102, EL lamp 104, and support 106; the hinge mechanism 110 rotatably positions table panel 102 relative to EL lamp 104.

Table panel 102 is generally formed of an opaque outer frame 112 extending around a perimeter of a light-transmissive (i.e. transparent or translucent) inner panel member 114 defining a viewing area. It is to be understood, however, that outer frame 112 could also be formed of light-transmissive materials. Typically, outer frame 112 is formed of rigid materials such as wood, metal, stone, fiberglass, and the like, and inner panel member 114 is formed of materials such glass, plexi-glass, plastic (polycarbonate, etc.) that allow light to pass through. Both frame 112 and panel member 114 can be formed into a variety of shapes, such as rectangles, circles, etc. Various means may be used to connect outer frame 112 to inner panel member 114, such as adhesives applied to the perimeter of inner panel member 114 whereby the outer frame is fitted onto the inner panel member perimeter. Alternatively, outer frame 112 has a tongue-in-groove configuration such that inner panel member 114 fits into the groove along outer frame inner edge. Preferably, outer frame 112 and inner panel member 114 are flush with one another such that table panel 102 forms a planar top surface 115 of the table system 100.

In an exemplary embodiment, electroluminescent lamp 104 is made according to the teachings of the '391 patent. The materials used for the EL lamp components may also include those disclosed in U.S. patent application Ser. No. 09/815,078, filed Mar. 22, 2001, for an “Electroluminescent Multiple Segment Display Device”, the teachings of which are incorporated by reference herewith. EL lamp 104 is typically planar, and is formed to have a shape that is similar to the shape chosen for the inner panel member 114 of table panel 102.

The component layers of electroluminescent lamp 104 are preferably built forward on a substrate. In this arrangement, EL lamp 104 is comprised of a substrate, a rear electrode formed onto the substrate, a dielectric layer formed over the rear electrode, a light emitting layer formed over the dielectric layer, a transparent front conductor formed over the light emitting layer, and optionally, a front electrode connected to the transparent front conductor. According to one embodiment, these EL lamp components are printed onto the substrate and made from the following materials: the substrate of metal, plastics, e.g. heat stabilized polycarbonate, or cardboard; the rear electrode of organics, such as polyaniline, polypyrrole, poly-phenyleneamine-imine, and preferably, polyethylene-dioxithiophene, which is available under the trade name “Orgacon” from Agfa Corp. of Ridgefield Park, N.J., or inorganics, such as silver or carbon particles dispersed in a polymeric ink; the dielectric layer of high dielectric constant material such as barium titanate; the light emitting layer of organics, such as light-emitting polymers/organic light emitting diodes, or non-organics, such as phosphors; the transparent front conductor of organics, such as polyaniline, polypyrrole, poly-phenyleneamine-imine, and preferably, polyethylene-dioxithiophene, or inorganics, such as indium-tin-oxide; and front electrode of organics, such as polyaniline, polypyrrole, poly-phenyleneamine-imine, and preferably, polyethylene-dioxithiophene, or inorganics such as silver or carbon particles dispersed in a polymeric ink. Optionally, a background layer or sign substrate having certain transparent and optically opaque areas can be placed over the EL lamp 104 as taught in the '391 patent to form a specific illuminated design made into the shape of illuminated images (wording, logos, icons, etc.). The background layer may, for example, be formed of number of colored printable inks. Additionally, illuminated images can be formed by positioning the light emitting layer of the EL lamp 104 in the form of such images. To bring electrical energy to EL lamp 104 for illumination, an electrical connector 116 is attached to front and rear electrode leads at a perimeter of lamp 104.

Positioned beneath electroluminescent lamp 104 is underlying support 106, which provides a foundation upon which lamp 104 rests. Underlying support 106 has a recessed body section 118 configured to receive EL lamp 104 and an outer ledge 120 upon which table panel 102 is mounted. Recessed body section 118 is sized and configured such that an EL lamp upper surface 121 will be generally flush with outer ledge 120, and will position EL lamp 104 to be underneath the inner panel member 114. Additionally, recessed body section 118 is configured to receive electrical connector 116 flush with outer ledge 120. The mounting of table panel 102 to outer ledge 120 is accomplished by hinge mechanism 110 positioned such that panel 102 rotates towards and away from underlying support 106 and EL lamp 104 in a “clamshell” like fashion. Outer ledge 120 also presents a planar surface configured to mate with outer frame 112 of table panel 102. If desired, a gasket (not shown) may be positioned on outer ledge 120 near a perimeter of the ledge to keep liquids and other substances from infiltrating the gap between table panel 102 and underlying support 106 when panel outer frame 112 is rotated to mate with underlying support outer ledge 120. A locking post member 122 may be provided on a side of the outer frame 112 to be received by a receiving member 124 on the outer ledge 120 to lock table panel 102 onto underlying support 106. Post member 122 should be positioned on an opposite side of the outer frame from hinge mechanism 110. In an alternative embodiment, underlying support 106 is not required as EL lamp 104 has a perimeter region configured for mounting directly to table panel 102 by fasteners, adhesives, or other means.

In accordance with one embodiment, underlying support 106 is mounted onto a table base 108 on a lower side 126 opposite of the table panel 102 and electroluminescent lamp 104. Table base 108 may be a pedestal, a plurality of table legs, or another other structure that provides a sturdy foundation for the table panel 102, EL lamp 104, and underlying support 106. The mounting of underlying support 106 to table base 108 may be by fasteners or other means that rigidly couple support 106 and base 108 together. In an alternative embodiment, underlying support 106 and table base 108 are formed as a unitary member. Table base 108 is ideally hollow so that a power source (not pictured) and electrical cord may be stored therein and connected to electrical connector 116. The power source may comprise a battery or a standard electrical outlet (e.g., 120 volts), and may be mounted, for example, to lower side 126 of underlying support 106. Optionally, a controller (not pictured), such as a microprocessor and memory, may be electrically connected to the power source or directly to EL lamp 104. The controller varies the illumination pattern of the lamp by, for example, illuminating certain regions of the lamp at specific time intervals (e.g., successively illuminating the letters “C-O-L-A” formed on the lamp), or by varying the intensity of illumination, thereby creating a moving light image.

By way of use, table panel 102 is rotated away from underlying support 106 and EL lamp 104 is placed into recessed body section 118. Then, electrical connector 116 is connected to a power supply to receive electrical energy for illumination of EL lamp 104. Table panel 102 may then be rotated towards underlying support 106 to abut and overlie such support 106. If locking post member 122 is provided, the member is inserted into receiving member 124 to lock panel table panel 102 and underlying support together 106, securing EL lamp 104 within table system 100. When it is desired to remove EL lamp 104 and replace it with another lamp illuminating a different image, locking post member may be released from receiving member 124 and table panel 102 rotated away from underlying support 106 to access the lamp.

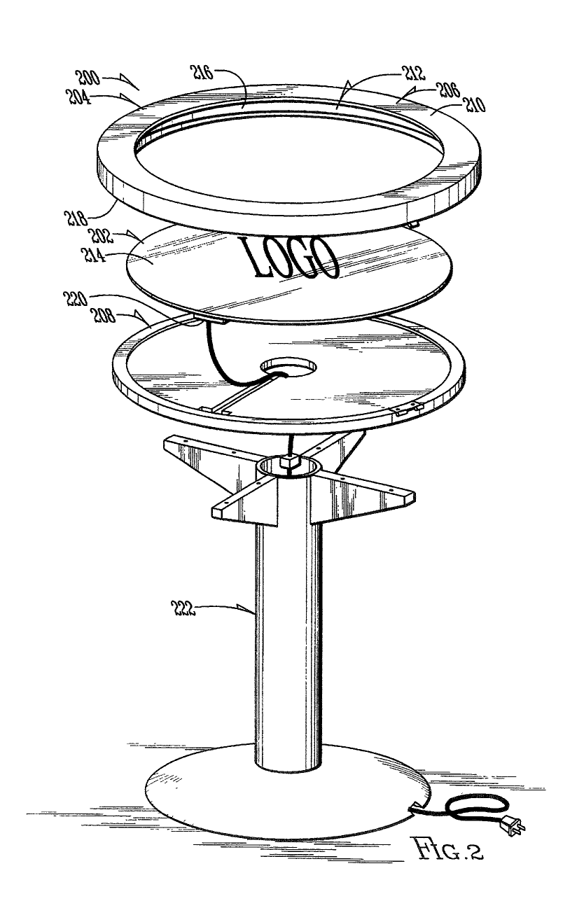

FIG. 2 presents another embodiment of the integrated electroluminescent lamp and table system 200 of the present invention wherein electroluminescent lamp 202 is integrated with table panel 204 to form table top surface 206. This configuration dispenses with the light-transmissive inner panel member 114 of table panel 102 in the embodiment of the invention shown in FIG. 1. A generally planar underlying support 208 maintains the position of EL lamp 202 relative to table panel 204.

Table panel 204 comprises an outer frame 210 having a hollow center 212 defining a viewing area. Table panel 204 may come in a variety of shapes, such as rectangular and circular such that outer frame 210 forms an outer member. Panel center 212 is sized and configured such that any illuminating regions of electroluminescent lamp 202 can be positioned below panel center 212 for viewing. In this configuration, EL lamp 202 combines with an upper surface 214 of table panel 204 to form table top surface 206. An optional gasket (not shown) may be positioned at an inner perimeter 216 of table panel 204 to abut EL lamp 204 and keep liquids and other substances from infiltrating the area below panel 204 and damaging the integrity of the lamp. In an exemplary embodiment, table panel 204 has a perimeter sidewall 218 extending away from upper surface 214 and configured to surround a perimeter of EL lamp 202 and underlying support 208. This configuration allows table panel 204 to act as a receiver for both the EL lamp 202 and underlying support 208, securing placement of EL lamp 202 between panel 204 and support 208. In accordance with one embodiment, the diameter across outer frame 210 of table panel 204 inside of the perimeter sidewall 216 is such as to be approximately equal to the diameter of EL lamp 202 and underlying support 208 such that table panel 204 may be frictionally fit over lamp 202 and support 208. Alternatively, adhesives, fasteners, and other means may be used to affix table panel 204 to underlying support 208 to sandwich EL lamp 202 therebetween. However, such affixing means should not permanently attach table panel 204 to underlying support 208 if it is desired to replace EL lamp 202 from time to time.

As with the embodiment of the present invention shown in FIG. 1, the electroluminescent lamp 204 of FIG. 2 is preferably made according to the teachings of the '391 patent, and may incorporate the EL lamp component materials disclosed in U.S. patent application Ser. No. 09/815,078. The component layers of the lamp 202 are preferably built on a reverse side of a substrate, such that the substrate combines with table panel 204 to form table top surface 206. The substrate must be light-transmissive such that the illumination provided by EL lamp 202 may be seen outside table system 200. Suitable substrate materials include glass, plexi-glass, plastic (polycarbonate, etc.), and the like. In this arrangement, EL lamp 204 comprises a substrate, a front electrode lead, a transparent front conductor formed onto the substrate, a light emitting layer formed over the transparent front conductor, a dielectric layer formed over the light emitting layer, and a rear electrode formed over the dielectric layer. These EL lamp components may be printed onto the substrate. To form specific illuminated images, the light-transmissive substrate may have certain optically opaque areas formed thereon by, for example colored printable inks, as discussed for the embodiment of the present invention shown in FIG. 1. Additionally, illuminated images can be formed by shaping the light emitting layer of EL lamp 202 in the form of such images. To receive electrical energy for illumination of EL lamp 202, an electrical connector 220 is attached to front and rear electrode leads at the lamp perimeter.

In accordance with one embodiment, lamp and table system 200 has a table base 222, power source (not pictured), and controller (not pictured) having the same structure and functionality as the embodiment of the present invention shown in FIG. 1. Underlying support 208 is preferably mounted onto a hollow table base 222 such that the power source and controller can be positioned within the base. In an alternative embodiment, underlying support 208 and table base 222 are formed as a single unitary member.

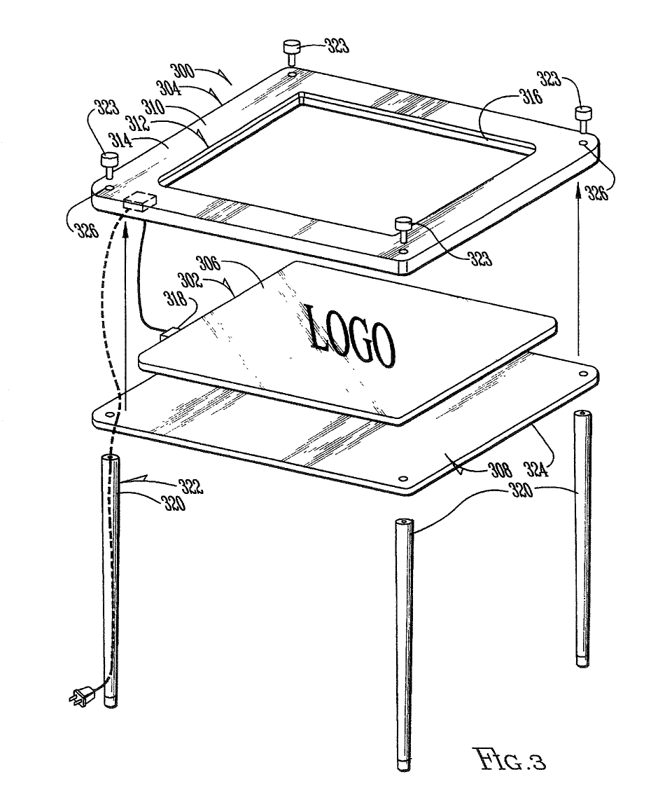

Another embodiment of the integrated electroluminescent lamp and table system 300 of the present invention is shown in FIG. 3. The table system 300 provides electroluminescent lamp 302 integrated with table panel 304 to form table top surface 306. A planar underlying support 308, as in the embodiment of FIG. 2, maintains the position of EL lamp 302 relative to table panel 304.

Table panel 304 comprises an outer frame 310 having a hollow center 312 defining a viewing area. Table panel 304 may come in a variety of shapes, such as rectangular, circular, etc. Panel center 312 is sized and configured such that any illuminating regions of electroluminescent lamp 302 can be positioned below panel center 312 for viewing. In this configuration, EL lamp 302 combines with an upper surface 314 of table panel 304 to form table top surface 306. An optional gasket (not shown) may be positioned at an inner perimeter 316 of table panel 304 to abut EL lamp 302 and keep liquids and other substances from infiltrating the area below panel 304 and damaging the integrity of the lamp.

The electroluminescent lamp 302 of FIG. 3 is preferably the same lamp as that shown in FIG. 2, except that it may have a different overall shape (i.e. rectangular versus circular). The component layers of the lamp 302 are preferably built on a reverse side of a light-transmissive substrate, such that the substrate combines with table panel 304 to form table top surface 306. Illuminated images can be formed by shaping the light emitting layer of EL lamp 302 in the form of such images, or by forming such images onto the substrate with colored printable inks, as an example. To receive electrical energy for illumination of EL lamp 302, an electrical connector 318 is preferably attached to front and rear electrode leads at the lamp perimeter.

A plurality of table legs 320 for a table base 322 and are configured to support and rigidly couple together the electroluminescent lamp 302, table panel 304 and underlying support 308. A plurality of fasteners 323 each secure to an upper section 324 of a table leg 320 to sandwich EL lamp 302, panel 304, and support 308 therebetween. According to one embodiment, fasteners 323 are male members comprising top caps having a threaded screw extending therefrom and configured for insertion into a threaded receiver of table leg upper sections 324. In an alternative embodiment, fasteners 323 are female members comprising top caps having a threaded receiver formed therein and configured to receive threaded screws extending from table leg upper sections 324. Both table panel 304 and underlying support 308 have a plurality of apertures 326 configured to align with the plurality of table legs 320 such that the threaded screws of either of the fasteners 323 or the table legs 320 can extend therethrough. Both fasteners 323 and table legs 320 are configured to have a cross-sectional dimension that is larger than the apertures 326 of table panel 304 and underlying support 308 such that panel 304 and support 308 can be contacted and held therebetween.

In accordance with one embodiment, integrated electroluminescent lamp and table system 300 also includes a power source (not pictured) and a controller (not pictured) having the same structure and functionality as the embodiment of the present invention shown in FIG. 1. The power source and controller may be mounted to a lower side 324 of underlying support 308.

By way of use, fasteners 323 may be removed from connection with table legs 320 such that table panel 304 may be removed from the underlying EL lamp 302. Such EL lamp 302 can then be removed and another lamp positioned beneath the panel center 312 of table panel 304. Fasteners may then be reconnected to table legs 320 to secure placement of EL lamp 302 between table panel 304 and underlying support 308.

### Integrated EL Lamp and Vending Machine System

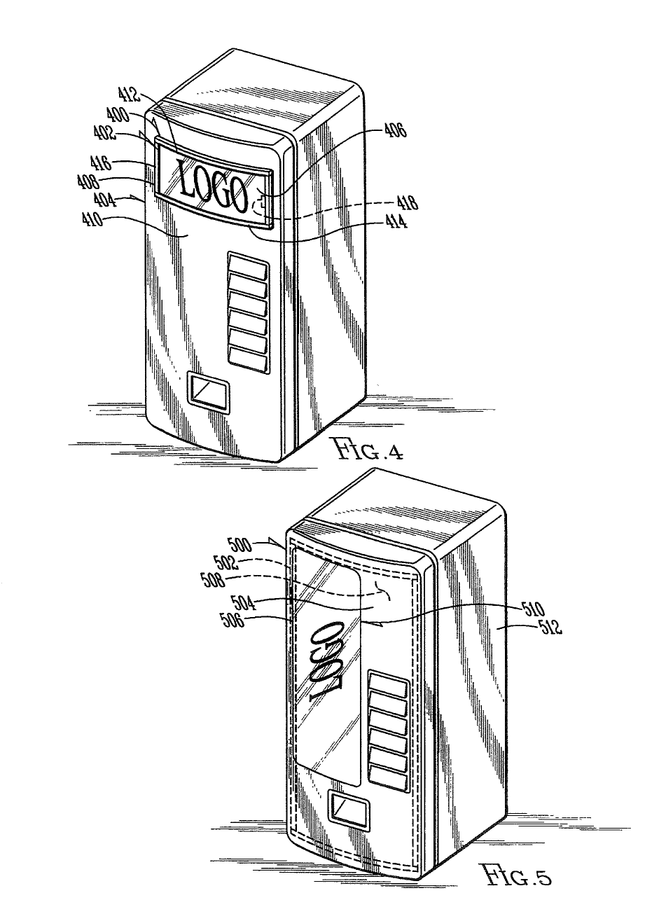

An integrated electroluminescent lamp and vending machine panel system 400 is shown in FIG. 4. System 400 provides another embodiment of the present invention comprising a framing unit 402 connected to a vending machine panel 404 (e.g., a panel of a vending machine access door) and configured for receiving an electroluminescent lamp 406 therein.

Vending machine panel 404 may be formed with certain images thereon (product logos, etc.). Panel 404 is typically made of glass, plexi-glass, plastic (polycarbonate, etc.), and similar materials. A reserved area 408 is created on a front surface 410 of vending machine panel 404 where the framing unit 402 is disposed. Reserved area 408 is generally a location on panel 404 which is image-free, or where it is unnecessary for a customer to view the image that may be blocked by placement of EL lamp 406 within framing unit 402. The framing unit 402 preferably has an upper frame member 412, lower frame member 414, and side frame members 416, one of which is removably attached to the other members. In this configuration, the removable frame member is removed and EL lamp 406 is slidingly received within the remaining frame members of frame unit 402. Then, the removed member can be reattached to the remaining members, forming a complete frame unit 402 holding EL lamp 406 is place at perimeter edges of the lamp. The frame members may be held together by fasteners, a tongue-in-groove configuration, or other methods. Likewise, framing unit 402 may be mounted onto vending machine panel 404 by fasteners, adhesives, or other methods. EL lamp 406 has an electrical connector 418 attached thereto at a perimeter of the lamp to receive electrical energy for illumination. A power source (not pictured) and a controller (not pictured) having the same structure and functionality as the embodiment of the present invention shown in FIG. 1 may also be provided. Alternatively, EL lamp 406 may be electrically connected to the power source of the vending machine.

Another embodiment of the integrated electroluminescent lamp and vending machine panel system 500 is shown in FIG. 5. Similar to the embodiment shown in FIG. 4, the system 500 provides a housing structure 502 formed onto a vending machine panel 504 and configured for receiving an electroluminescent lamp 506. However, housing structure 502 is disposed on a back surface 508 of vending machine panel 504 over a reserved or viewing area 510 such that EL lamp 506 is disposed within vending machine 512 and viewed through panel 504 by an outside observer. Reserved area 510 is formed as a light-transmissive section of panel 504 such that the illumination pattern of EL lamp 506 may be seen therethrough.

According to one embodiment, reserved area 510 is formed as follows: a typical vending machine panel 504 made of light-transmissive materials (glass, plexi-glass, polycarbonate plastics, etc.) is chosen and a vinyl film block, or material exhibiting similar properties, shaped and configured be the size of reserved area 510 is placed on the panel; a desired image is formed onto back surface 508 of panel 504; vinyl film block is then removed to leave a light-transmissive, and preferably fully transparent, reserved area through which EL lamp 506 may be directly viewed.

Housing structure 502 may comprise the frame unit 402 of the embodiment of the invention of FIG. 4 mounted onto back surface 508 of vending machine panel 504. In this configuration, because the EL lamp 506 is located within the vending machine 512, there is reduced risk of tampering or theft of the lamp. Thus, an upper frame member or one of the side frame members are not required as part of housing structure 502 such that EL lamp 506 is only surrounded by frame members on three sides and can be easily slid in and out of structure 502 without disassembly thereof. According to another embodiment, housing structure 502 is molded onto the panel back surface 508 and is preferably made from the same material as the vending machine panel 504 (glass, plexi-glass, polycarbonate plastics, etc.). Housing structure 502 is molded as a three-sided receiver (i.e. either a lower member and two side members, or a lower member, one side member, and one upper member), such that EL lamp 506 may be slidably received and removed from housing structure 502. A power source (not pictured) and a controller (not pictured) having the same structure and functionality as the embodiment of the present invention shown in FIG. 1 may also be provided. Alternatively, EL lamp 506 may be electrically connected to the power source of the vending machine.

What is claimed is:

1. A method for forming an illuminated display system, comprising:
forming a table panel having a light-transmissive viewing area; and
positioning an electroluminscent lamp relative to the table panel such that the lamp is viewable through the viewing area.

2. The method of claim 1, further comprising the step of connecting an electrical connector to the electroluminescent lamp to transport energy from a power source to the electroluminescent lamp for illuminatoin thereof.

3. The method of claim 1, further comprising coupling a controller to the electroluminescent lamp to vary the illumination of the lamp at specific time intervals.

4. The method of claim 1, wherein the step of forming a table panel comprises:
forming a light-transmissive panel to define a viewing area;
forming an outer frame generally circumscribing the panel; and
rigidly coupling the outer frame to the translucent panel.

5. A method for forming an illuminated display system, comprising:
forming an electroluminescent lamp onto a light-transmissive substrate;
placing an underlying support below the electroluminescent lamp; and
placing an outer frame generally over a perimeter region of the electroluminescent lamp.

6. The method of claim 5, further comprising the steps of:
mounting a table base to the underlying support to provide structural support to the outer frame, electroluminescent lamp and underlying support; and
mounting the outer frame to one of the illuminated display system components selected from the group consisting of the underlying support or the table base to secure placement of the electroluminescent lamp between the outer frame and the underlying support.

7. The method of claim 5, wherein the step of forming an electroluminescent lamp onto a light-transmissive substrate comprises:
forming a transparent front conductor onto the light-transmissive substrate;
forming a light emitting layer onto the transparent conductive layer;
forming a dielectric layer onto the light emitting layer; and
forming a rear electrode onto the dielectric layer.

8. An illuminated display system, comprising:
a table panel having a light-transmissive viewing area;
an electroluminescent lamp positioned beneath the table panel such that the lamp is viewable through the viewing area; and
means for positioning the table panel relative to the electroluminescent lamp.

9. The system of claim 8, wherein the means for positioning the table panel relative to the electroluminescent lamp comprises an underlying support positioned beneath the electroluminescent lamp, the table panel being interconnected with the underlying support to secure the placement of the electroluminescent lamp therebetween.

10. The system of claim 9, wherein the table panel comprises an outer frame having a hollow viewing area, the outer frame having a perimeter sidewall extending away from a planar surface of the panel and configured to surround a perimeter of the electroluminescent lamp and a perimeter of the underlying support.

11. The system of claim 8, wherein the means for positioning the table panel relative to the electroluminescent lamp further comprises a hinge mechanism for rotatably mounting the table panel onto the underlying support.

12. The system of claim 11, wherein the table panel has a locking post disposed thereon a and the underlying support has a locking post receiver disposed thereon for receiving the locking post when the table panel is rotated to fully overlie the electroluminescent lamp.

13. The system of claim 8, wherein the means for positioning the table panel relative to the electroluminescent lamp further comprises a table base positioned beneath the underlying support, the base configured to provide structural support to the table panel, the electroluminescent lamp, and underlying support.

14. The system of claim 13, wherein the table base comprises a pedestal onto which the underlying support is mounted.

15. The method of claim 13, wherein the table base comprises a plurality of table legs onto which the underlying support is mounted.

16. The method of claim 15, wherein the means for positioning the table panel relative to the electroluminescent lamp further comprises a plurality of fasteners configured to extend though a plurality of apertures of the table panel and a plurality of apertures of the underlying support and rigidly couple with the table legs, such that the table panel, electroluminescent lamp, and underlying structure are fixedly positioned between the plurality of fasteners and the plurality of table legs.

17. The system of claim 13, further comprising a power source positioned within the table base and electrically connected to the electrical connector.

18. The system of claim 8, wherein the means for positioning the table panel relative to the electroluminescent lamp further comprises a table base positioned beneath the electroluminescent lamp, the base configured to provide structural support to the table panel and the electroluminescent lamp.

19. The system of claim 8, wherein the table panel comprises an outer frame having a hollow viewing area.

20. The system of claim 19, wherein the electroluminescent lamp comprises:
a light-transmissive substrate;
a transparent front conductor formed onto the light-transmissive substrate;
a light emitting layer formed onto the transparent front conductor;
a dielectric layer formed onto the light emitting layer; and
a rear electrode formed onto the dielectric layer.

21. The system of claim 8, wherein the means for positioning the table panel relative to the electroluminescent lamp comprises a plurality of fasteners rigidly coupling the table panel and the electroluminescent lamp together.

22. The system of claim 8, further comprising a controller coupled to the electroluminescent lamp to vary the illumination of the lamp at specific time intervals.

23. A method for forming an illuminated display system, comprising:
forming a vending machine outer panel with a light-transmissive viewing area; and
positioning an electroluminescent lamp behind the outer panel such that the lamp is viewable through the viewing area.

24. The method of claim 23, wherein the step of positioning an electroluminescent lamp behind the outer panel comprises placing the electroluminescent lamp into a receiver mounted onto a back surface of the outer panel and aligned with the light-transmissive area.

25. The method of claim 23, wherein the step of positioning an electroluminescent lamp behind the outer panel comprises rigidly attaching the electroluminescent lamp to a back surface of the outer panel aligned with the light-transmissive area.

26. An illuminated display system, comprising:
a vending machine outer panel having a forward side, a reverse side, and a light-transmissive viewing area;
an electroluminescent lamp positioned adjacent to the outer panel reverse side such that the lamp is viewable through the viewing area; and
means for positioning the electroluminescent lamp relative to the outer panel.

27. The system of claim 26, wherein the means for positioning the electroluminescent lamp comprises a receiver mounted onto the outer panel reverse side and over the viewing area, the receiver being configured for accepting the electroluminescent lamp therein.
